(19) United States
(12) Patent Application Publication
(10) Pub. No.: US 2010/0214368 A1
(43) Pub. Date: Aug. 26, 2010

(54) INK-JET HEAD

(75) Inventors: Boum-Seock Kim, Suwon-si (KR); Jae-Woo Joung, Suwon-si (KR); Ju-Hwan Yang, Suwon-si (KR); Young-Seuck Yoo, Seoul (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD

(21) Appl. No.: 12/505,810

(22) Filed: Jul. 20, 2009

(30) Foreign Application Priority Data
Feb. 25, 2009 (KR) 10-2009-0015987

(51) Int. Cl. B41J 2/045

(52) U.S. Cl. 347/68

(57) ABSTRACT

A ink-jet head is disclosed. The ink-jet head includes a chamber, which accommodates ink, a nozzle, which is coupled to the chamber to allow the ink to be ejected, a membrane, which is formed on the chamber at a side opposite to the nozzle, a first actuator, which is coupled to the membrane and configured to deform the membrane, and a second actuator, which is coupled to one side of the chamber and configured to deform the membrane. In accordance with an embodiment of the present invention, the ink-jet head can provide the required displacement of the membrane, even with a thin-film type actuator.

### CROSS-REFERENCE TO RELATED APPLICATIONS

This application claims the benefit of Korean Patent Application No. 10-2009-0015987, filed with the Korean Intellectual Property Office on Feb. 25, 2009, the disclosure of which is incorporated herein by reference in its entirety.

### BACKGROUND

1. Technical Field

The present invention relates to an ink-jet head.

2. Description of the Related Art

An ink-jet printer is an apparatus for ejecting droplets of ink through a nozzle by transforming an electric signal to a physical force. The ink-jet head may be manufactured by forming different components, such as a chamber, a restrictor, a nozzle and a piezoelectric body, in several layers and stacking these layers on one another.

In recent years, the application of the ink-jet head has expanded beyond the graphic printing industry, to manufacturing printed circuit boards and electronic parts, such as LCD panels.

Accordingly, various functions that have not been required in the conventional fields of graphic printing are now required in current ink-jet printing applications for manufacturing electronic components, in which it is critically important to eject the ink with high precision and accuracy. Such functions may include reductions in the size of the droplets being ejected and the deviation of ejecting speed, as well as higher densities of nozzles and higher frequencies for increasing production.

The operation of a conventional ink-jet head may utilize the piezoelectric property of a thick-film type piezoelectric body coupled to the chamber. Although the thick-film type piezoelectric body offers certain advantages, such as easy production and superior piezoelectric properties, it may also entail certain disadvantages as well. For example, if the thickness of the piezoelectric body is reduced in order to decrease the operating voltage, the piezoelectric property may also be deteriorated, and there may be a limit to reducing the thickness of the thick-film type piezoelectric body, due to the difficulty of the bonding and dicing processes.

On the other hand, in the case of a thin-film type piezoelectric body, an actuator with a lower thickness can be implemented and a desired structure can be manufactured by using vapor deposition and patterning processes without a dicing process. Nevertheless, the application of the thin-film type piezoelectric body as an actuator for ejecting the ink may be limited, since the piezoelectric property of the thin-film type piezoelectric body is much lower than that of the thick-film type piezoelectric body.

### SUMMARY

An aspect of the present invention provides an ink-jet head that includes a thin-film type actuator.

Another aspect of the present invention provides an ink-jet head that includes: a chamber for accommodating ink; a nozzle coupled to the chamber to enable an ejection of the ink; a membrane formed on the chamber at a side opposite to the nozzle; a first actuator coupled to the membrane for deforming the membrane; and a second actuator coupled to one side of the chamber for deforming the membrane.

The second actuator can be coupled to either side of the chamber, and can surround side surfaces of the chamber.

The first actuator can include a piezoelectric body, and the piezoelectric body of the first actuator can extend and contract in both directions. The second actuator can include a piezoelectric body. Here, the piezoelectric body of the second actuator is can extend and contract in both directions, while the second actuator can extend and contract in both directions of the piezoelectric body.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a cross-sectional view illustrating an ink-jet head in accordance with an embodiment of the present invention.

FIG. 2 is a plan view illustrating an ink-jet head in accordance with an embodiment of the present invention.

FIG. 3 and FIG. 4 are cross-sectional views illustrating how an ink-jet head is operated in accordance with an embodiment of the present invention.

### DETAILED DESCRIPTION

The features and advantages of this invention will become apparent through the below drawings and description.

An ink-jet head according to a certain embodiment of the present invention will be described below in more detail with reference to the accompanying drawings. Those components that are the same or are in correspondence are rendered the same reference numeral regardless of the figure number, and redundant descriptions are omitted.

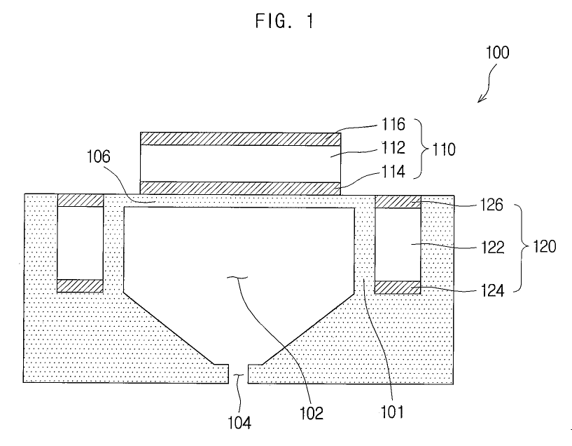

FIG. 1 is a cross-sectional view illustrating an ink-jet head 100 in accordance with an embodiment of the present invention. As in the example shown in FIG. 1, the ink-jet head 100 in accordance with an embodiment of the present invention can include a chamber 102, which accommodates ink, a nozzle 104, which is coupled to the chamber 102 to allow the ink to be ejected, a membrane 106, which is formed on the chamber 102 at a side opposite to the nozzle 104, a first actuator 110, which is coupled to the membrane 106 and configured to deform the membrane 106, and a second actuator 120, which is coupled to one side of the chamber 102 and configured to deform the membrane 106. In accordance with an embodiment of the present invention, the ink-jet head can provide the required displacement of the membrane 106, even with a thin-film type actuator.

The chamber 102 can be formed inside the ink-jet head 100 and provide a space for accommodating ink. The upper portion of the chamber 102 can be shaped as a rectangular cuboid, while the lower portion of the chamber 102 can be shaped with a gradually decreasing cross-sectional area toward the nozzle 104.

The nozzle 104 can be coupled to the chamber 102 so as to eject the ink. The nozzle 104 can be formed in the lower portion of the chamber 102 where the cross-sectional area is gradually decreased, providing a passage through which the ink held in the chamber 102 maybe ejected to the outside.

The membrane 106 can be formed on the chamber 102 at a side opposite to the nozzle 104. The membrane 106 can have the form of a thin-film, covering the upper portion of the chamber 102. The membrane 106 can transfer a vibration generated by the first actuator 110 to the ink held in the chamber 102, so that the ink may be ejected.

The first actuator 110 can be coupled onto the membrane 106, so as to deform the membrane 106, and can include a lower electrode 114 coupled onto the membrane 106, a piezoelectric body 112 coupled onto the lower electrode 114, and an upper electrode 116 coupled onto the piezoelectric body 112.

The body of the ink-jet head 100 in which the chamber 102 is formed can be formed by stacking a plurality of silicon wafers together, and the lower electrode 114 can be formed by depositing platinum (Pt) and titanium (Ti) onto the silicon wafers.

The piezoelectric body 112 can be formed as a thin-film type by depositing a piezoelectric material onto the lower electrode 114. The thin-film type piezoelectric body 112 formed by deposition can be operated with a relatively lower operating voltage than a thick-film type piezoelectric body, so that the operating voltage of the ink-jet head 100 can be reduced. Thus, the thin-film type piezoelectric body 112 can improve the electrical properties of the ink-jet head 100.

The upper electrode 116 can be formed by depositing platinum (Pt) onto the piezoelectric body 112. The upper electrode 116 and the lower electrode 114 can provide electrical connection to the piezoelectric body 112, so that the piezoelectric body 112 may be operated.

When an electric voltage is supplied to the piezoelectric body 112 through the upper electrode 116 and the lower electrode 114, the piezoelectric body 112 can be polarized, so that the piezoelectric body 112 is extended in both directions. The piezoelectric body 112 of the present embodiment, having the form of a square thin film, can be extended in four directions (i.e., the top, bottom, left, and right directions) to increase the area of the square, when an electric voltage is supplied to the piezoelectric body 112. When an electric voltage is not supplied to the piezoelectric body 112, the piezoelectric body 112 can return to its original form.

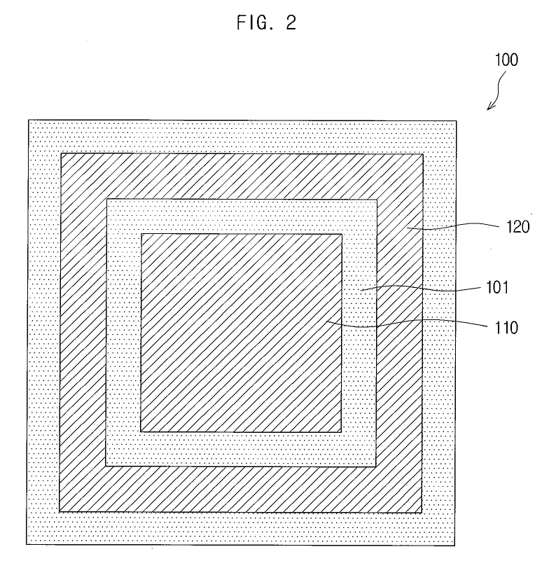

FIG. 2 is a plan view illustrating the ink-jet head 100 in accordance with an embodiment of the present invention. As illustrated in FIGS. 1 and 2, the second actuator 120 may surround the side surfaces of the chamber 102 to deform the membrane 106.

The second actuator 120 can be formed adjacent to the side walls 101 of the chamber 102, surrounding the side walls 101 of the chamber 102. A lower electrode 124 of the second actuator 120, similar to the lower electrode 114 of the first actuator 110, can be formed by depositing platinum (Pt) and titanium (Ti) onto the silicon wafers of the ink-jet head 100 in which the chamber 102 is formed.

A piezoelectric body 122 of the second actuator 120 can be formed as a thin film by depositing a piezoelectric material onto the lower electrode 124. The thin-film type piezoelectric body 122 can be operated with a relatively lower operating voltage than a thick-film type piezoelectric body, so that the operating voltage of the ink-jet head 100 can be reduced.

An upper electrode 126 of the second actuator 120 can be formed by depositing platinum (Pt) onto the piezoelectric body 122 of the second actuator 120.

When an operating voltage is supplied to the second actuator 120, the piezoelectric body 122 of the second actuator 120 may extend in both directions. Since the second actuator 120 is formed in an annular shape along the side walls 101 of the chamber 102, the piezoelectric body 122 of the second actuator 120 can extend toward both the inside and outside of the annular piezoelectric body 122.

Consequently, by pushing the side walls 101 of the chamber 102 toward the inside of the chamber 102, the second actuator 120 can provide support when the first actuator 110 deforms the membrane 106 in an upward direction.

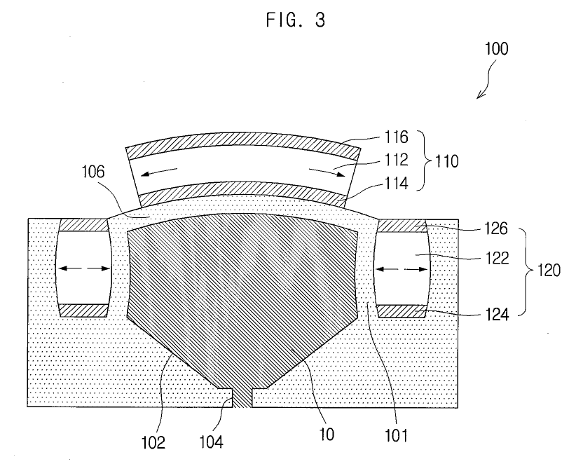

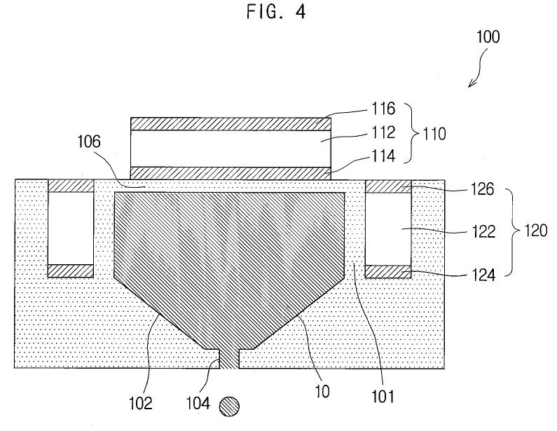

FIGS. 3 and 4 are cross-sectional views illustrating how the ink-jet head 100 is operated in accordance with an embodiment of the present invention. As illustrated in FIG. 3, when an electric voltage is supplied to the first actuator 110 and the second actuator 120, the piezoelectric bodies 112 and 122 of the first actuator 110 and the second actuator 120 can be extended in both directions, respectively. Then, the membrane 106 on the upper portion of the chamber 102 may bulge in an upward direction of the chamber 102, while the side walls 101 of the chamber 102 may contract in an inward direction of the chamber 102, allowing the membrane 106 to bulge upward. As a result, the volume inside the chamber 102 can be increased.

Next, as illustrated in FIG. 4, if an electric voltage is not supplied to the first actuator 110 and the second actuator 120, the first actuator 110 and the second actuator 120 can return to their original shapes, and the membrane 106 and the side walls 101 of the chamber 102 can also return to their original shapes. As a result, the volume inside the chamber 102 may be decreased, and thus the ink can be ejected to the outside of the ink-jet head 100 through the nozzle 104.

As described above, in an ink-jet head 100 in accordance with an embodiment of the present invention, the first actuator 110 and the second actuator 120 can be implemented using thin-film type piezoelectric bodies 112 and 122, so that the operating voltage of the ink-jet head 100 can be reduced and the electrical property of the ink-jet head 100 can be improved. Moreover, the ink-jet head 100 can be equipped with a second actuator 120 that is formed on a side surface of the chamber 102, thus obtaining sufficient displacement of the membrane 106.

While the spirit of the present invention has been described in detail with reference to a particular embodiment, the embodiment is for illustrative purposes only and shall not limit the present invention. It is to be appreciated that those skilled in the art can change or modify the embodiment without departing from the scope and spirit of the present invention. As such, many embodiments other than that set forth above can be found in the appended claims.

What is claimed is:

1. An ink-jet head comprising:
a chamber configured to accommodate ink;
a nozzle coupled to the chamber and configured to enable an ejection of the ink;
a membrane formed on the chamber at a side opposite to the nozzle;
a first actuator coupled to the membrane and configured to deform the membrane; and
a second actuator coupled to one side of the chamber and configured to deform the membrane.

2. The ink-jet head of claim 1, wherein the second actuator is coupled to either side of the chamber.

3. The ink-jet head of claim 2, wherein the second actuator surrounds side surfaces of the chamber.

4. The ink-jet head of claim 1, wherein the first actuator comprises a piezoelectric body.

5. The ink-jet head of claim 4, wherein the piezoelectric body of the first actuator is configured to extend and contract in both directions.

6. The ink-jet head of claim 4, wherein the second actuator comprises a piezoelectric body.

7. The ink-jet head of claim 6, wherein the piezoelectric body of the second actuator is configured to extend and contract in both directions.

8. The ink-jet head of claim 7, wherein the second actuator is configured to extend and contract in both directions of the piezoelectric body.
